(19) United States
(12) Patent Application Publication
(10) Pub. No.: US 2009/0268444 A1
(43) Pub. Date: Oct. 29, 2009

(54) Decorative Lighting Display

(76) Inventors: Adam Fair, Solon, OH (US); Margo Fair, Solon, OH (US)

Correspondence Address: CURATOLO SIDOTI CO., LPA, 24500 CENTER RIDGE ROAD, SUITE 280, CLEVELAND, OH, 44145, US

(21) Appl. No.: 12/344,186

(22) Filed: Dec. 24, 2008

Related U.S. Application Data
(63) Continuation-in-part of application No. 11/732,185, filed on Apr. 3, 2007.
(60) Provisional application No. 60/788,768, filed on Apr. 3, 2006.

(51) Int. Cl. F21V 9/00; F21S 4/00; F21V 21/00

(52) U.S. Cl. 362/231; 362/249.16; 362/249.06; 362/391

(57) ABSTRACT

An electrically powered decorative assembly for interior or exterior display. The decorative assembly includes a main electrical string and one or more electrically wired light emitting ornaments electrically and detachably connected to the main string. The decorative assembly may further include one or more light emitting sources electrically connected to the main string. The decorative assembly may be displayed in celebration of religious holidays and secular occasions.

### CROSS REFERENCE TO RELATED APPLICATIONS

This application is a continuation-in-part of U.S. patent application Ser. No. 11/732,185, filed Apr. 3, 2006, which claims the benefit of the filing date under 35 U.S.C. 119(e) of U.S. Provisional Application For Patent Ser. No. 60/788,768, filed Apr. 3, 2006.

### TECHNICAL FIELD

The invention relates to a decorative lighting assembly for interior or exterior display. The decorative lighting assembly includes a string of detachably connected electrically wired light emitting ornaments and, optionally, a plurality of electrically powered lights. The decorative lighting assembly may be displayed in celebration of religious holidays and non-religious occasions.

### BACKGROUND

It is common for people to decorate their homes, offices, and other locations for festive occasions such as religious holidays, non-religious/secular celebrations, or even for entire seasons. Such displays increase the festive atmosphere surrounding the holiday or secular celebration and allow people to express their creativity and artistry.

Light assemblies continue to gain increasing popularity. Such light assemblies are used as indoor and outdoor decorations. The light assemblies generally include a string of electrically powered lights spaced at intervals along the string. For example, many people hang strings of lights on the exterior of their homes to celebrate the Christmas season. More recently, exterior lighting assemblies directed to other religious holidays and non-religious celebrations have gained acceptance.

However, the light assemblies generally include lights that emit colors that are indicative of a particular holiday and, therefore, are not interchangeable for different holidays. Thus, those wishing to decorate their homes to celebrate more than one different holiday or secular occasion are compelled to purchase a number of different decorative light assemblies. In addition, the Jewish community is underserved as there are virtually no decorative light assemblies which are intended to be used in connection with the celebration of the Jewish holiday Hanukkah.

In view of the foregoing, it would be desirable to provide a decorative lighting display that is readily adaptable to different religious holidays, non-religious celebrations/occasions, or for entire seasons.

### SUMMARY

Disclosed is a decorative light assembly that includes a main electrical string and connections for electrically connecting interchangeable components to the electrical string, thereby providing a decorative light assembly that is readily adaptable for display in celebration of a wide variety of different religious holidays, non-religious celebrations/secular occasions, or even for entire seasons.

An electrically wired light emitting ornament comprising a base, electrical wiring attached to said base, a light emitting source in electrical connection with said electrical wiring, and a connector for connecting said ornament to a source of electricity.

A decorative assembly or display is also provided, the decorative assembly comprises an elongated electrical string and at least one electrically wired and detachably connected light emitting ornament pendant from said string.

According to certain embodiments, the decorative lighting assembly comprises an elongated electrical string having at least one connector adapted for electrically connecting an electrically wired ornament to said electrical string; and at least one electrically wired light emitting ornament electrically and detachably connected to said electrical string.

According to other embodiments, a decorative lighting assembly is provided, the decorative lighting assembly comprises a string of electrically connected lights, and at least one electrically wired light emitting ornament electrically and detachably connected to said string.

According to certain illustrative embodiments, the decorative lighting assembly comprises an elongated main electrical string; at least one secondary string transversely arranged and electrically connected to said main string; and at least one electrically wired light emitting ornament electrically and detachably connected to at least one of said main and secondary electrical strings.

A decorative lighting assembly kit is also provided, said kit comprises an electrical string of electrically connected receptacles; and at least one of (i) a plurality of light emitting ornaments adapted for electrical connection with at least one of said electrically connected receptacles, or (ii) a combination of (a) a plurality of light emitting ornaments adapted for electrical connection with at least one of said electrical connectors and (b) a plurality of different colored light emitting sources adapted for electrical connection with at least one of said electrical connectors.

### BRIEF DESCRIPTION OF THE DRAWINGS

FIG. 1 shows a front perspective view of one illustrative embodiment of the decorative lighting assembly.

FIG. 2 shows a front perspective view of another illustrative embodiment of the decorative lighting assembly.

FIG. 3 shows a front perspective view of a further illustrative embodiment of the decorative lighting assembly.

FIG. 4 shows a front plan view of an illustrative light emitting ornament.

### DETAILED DESCRIPTION

A decorative assembly comprising an elongated electrical string and at least one electrically and detachably connected ornament pendant from the string is disclosed. A decorative assembly comprising an elongated electrical string or electrical cord and at least one electrically and detachably connected ornament pendant from the electrical string is provided. The decorative assembly or display is customizable through the electrical connection of user-selectable light emitting ornaments that represent, without limitation, different holidays, secular occasions, seasons, sports teams, logos corporate entities, cartoon characters, symbols, numbers, letters, and the like. According to certain embodiments, the decorative lighting assembly includes both a string of lights and customizable or user-selectable ornaments. The decorative lighting assembly may be utilized for display in celebration of any religious holiday or non-religious occasion.

In certain embodiments, the decorative light assembly includes a string assembly comprising a string of receptacles or sockets electrically interconnected by an electrical cord and terminated by at least one electrical connector. A plurality of decorative light emitting sources, such as light emitting lamps or light emitting diodes, are mated with a portion of the receptacles. At least one electrically wired ornament is electrically connected to the main string of lights through a detachable connector, and is pendant from the main electrical string.

With respect to the string of electrically connected lights, depending on the religious holiday or non-religious celebration, different colors of lights may be selected. A plurality of red lights, a plurality of white lights, a plurality of blue lights, a plurality of green lights, a plurality of orange lights, or a plurality of gold/yellow lights, any other color, or combinations of any one or more colors may be selected by the user.

By way of example, the decorative lighting display may include a plurality of white lights which is indicative of the New Year's holiday celebration; a decorative lighting display celebrating the Valentine's/Sweetest Day holiday may include a plurality of red and white lights; an Independence/Memorial Day holiday display may include pluralities of red, white, and blue lights; a Halloween holiday setting may include pluralities of orange and gold/yellow lights; a Thanksgiving holiday display may include pluralities of orange, brown, and/or green lights; a Christmas holiday display may include pluralities of red and green lights; and a Hanukkah holiday display may include pluralities of blue and gold/yellow lights. The decorative lighting assembly may also be used to celebrate any life event, such as, without limitation, Bar Mitzvahs, Bat Mitzvahs, weddings, anniversaries, graduations, job promotions, retirement, the birth of a child, birthdays, and like celebrations.

The decorative assembly includes at least one light emitting ornament that is electrically connected to the main electrical string. A light emitting ornament includes a base, electrical wiring attached to the base, at least one light emitting source, such as a LED, in electrical connection with the electrical wiring, and a connector for detachably connecting the electrically wired ornament to a source of electricity. Without limitation, the electrical connection is made between the main electrical string and the ornament via male and female mating connectors.

The ornaments are generally indicative of a particular religious holiday or non-religious celebration. Without limitation, the light emitting ornaments may be indicative of one of the holiday or secular celebrations of New Year's, Christmas, Hanukkah, Kwanzaa, Valentine's Day, Sweetest Day, Easter, Memorial Day, Independence Day, Halloween, Thanksgiving and birthdays.

The ornaments are attached to the main electrical string in a manner such they are generally pendant from the main electrical string. The term “ornament(s)” refers to light emitting objects other than simple light emitting bulbs or lamps. The ornaments generally include at least one light emitting source, such as, for example, a light emitting lamp or light emitting diode (LED), that is positioned on the exterior surface of the ornament. Alternatively, the ornament may include at least one light emitting source (lamp or LED, for example) that is positioned or encased within the ornament, but which emits light through the ornament. Alternatively, the ornament may include at least one light emitting source (lamp or LED, for example) that is embedded with the ornament base. Alternatively, the ornament may include at least one light emitting source (lamp or LED, for example) that is positioned within a housing and the housing is engaged with the base. According to various other embodiments, the ornament may include a combination of light emitting sources that are positioned both inside the ornament and on the exterior surface of the ornament, or embedded with the ornament base and on the exterior surface of the ornament.

According to certain embodiments, the light emitting ornament may be indicative of the Jewish religious holiday of Hanukkah. With respect to embodiments where the decorative assembly includes light emitting ornaments that are indicative of the Jewish holiday of Hanukkah, the ornaments may, without limitation, be in the shape of the Star of David, the Menorah, the dradle, or combinations thereof.

The light emitting ornaments may also be indicative of the Christmas holiday. For embodiments of the decorative lighting assembly including ornaments that are indicative of the Christmas holiday, the ornaments may be, without limitation, in the general shape of a Christmas tree, an angel, a candy cane, a wrapped Christmas present, a Christmas stocking, a Christmas wreath, a bow, a peace sign, a bell, a dove, a representation of the North Star, a reindeer, a snowman, Santa Claus, Mrs. Claus, an elf, or combinations thereof.

The light emitting ornaments may also be indicative of the Thanksgiving holiday. For embodiments of the decorative lighting assembly including ornaments that are indicative of the Thanksgiving holiday, the ornaments may be, without limitation, in the general shape of a turkey, a pilgrim, a pumpkin, gourds, the cornucopia, a cornstalk, a bale of hay, and combinations thereof.

The light emitting ornaments may also be indicative of Halloween. For embodiments of the decorative lighting assembly including ornaments that are indicative of Halloween, the ornaments may be, without limitation, in the general shape of a carved pumpkin, a skeleton, a ghost, a witch, a bat, a vampire, a monster, a ghoul, and combinations thereof.

The light emitting ornaments may also be indicative of Valentine's or Sweetest Day. For embodiments of the decorative lighting assembly including ornaments that are indicative of Valentine's or Sweetest Day, the ornaments may be, without limitation, in the general shape of a heart, cupid, and combinations thereof.

The light emitting ornaments may also be indicative of the Easter holiday. For embodiments of the decorative lighting assembly including ornaments that are indicative of the Easter holiday, the ornaments may be, without limitation, in the general shape of an Easter bunny, a decorated Easter egg, an Easter basket, a Cross, and combinations thereof.

The light emitting ornaments may also be indicative of the Memorial or Independence holidays. For embodiments of the decorative lighting assembly including ornaments that are indicative of the Memorial or Independence Day holidays, the ornaments may be, without limitation, in the general shape or representation of the United States flag, a star, a representation of a fireworks display, an eagle, and combinations thereof.

According to certain embodiments, the decorative lighting display may include a plurality of ornaments that are indicative of professional sports teams, college sports teams, high school sports teams, logos that signify a certain city, community, state, or country, a representation of a trademark or logo of a business or corporate entity, symbols, numbers, letters, combinations of numbers and letters, fictional characters, cartoon characters, or combinations of the above.

The light emitting ornaments are connected to the main electrical string by a suitable connector. The connector member is configured to detachably and electrically connect user-selected ornaments to the main electrical string, to a secondary electrical string that is connected to the main string, or to both the main and secondary electrical strings.

According to certain embodiments, the decorative lighting assembly includes an elongated main electrical string, at least one secondary string transversely arranged and electrically connected to the main string, and at least one electrically wired light emitting ornament electrically and detachably connected to the main electrical string.

According to other embodiments, the decorative lighting assembly includes an elongated main electrical string; at least one secondary string transversely arranged and electrically connected to the main string, and at least one electrically wired light emitting ornament electrically and detachably connected to the secondary electrical string.

According to certain embodiments, the decorative lighting assembly includes an elongated main electrical string, at least one secondary string transversely arranged and electrically connected to the main string, and at least one electrically wired light emitting ornament electrically and detachably connected to both the main and secondary electrical strings.

According to certain embodiments, the decorative lighting assembly includes a main string of electrically connected lights, at least one secondary string transversely arranged and electrically connected to the main string, and at least one electrically wired light emitting ornament electrically and detachably connected to the main electrical string.

According to other embodiments, the decorative lighting assembly includes a main string of electrically connected lights, at least one secondary string transversely arranged and electrically connected to the main string, and at least one electrically wired light emitting ornament electrically and detachably connected to the secondary electrical string.

According to certain embodiments, the decorative lighting assembly includes a main string of electrically connected lights, at least one secondary string transversely arranged and electrically connected to the main string, and at least one electrically wired light emitting ornament electrically and detachably connected to both the main and secondary electrical strings.

It is desirable, but not required, to maintain the positioning of the light emitting ornaments that are connected to the main electrical string to maintain the aesthetic appearance of the display. Accordingly, the light emitting ornaments are electrically connected to the main electrical string of the decorative light assembly by a suitable connector that is configured in such a manner so as to substantially prevent the movement of the ornament, such as preventing rotational movement of the selected ornaments when exposed to the outside environmental factors, such as wind and driving rain, hail, sleet, slush, or snow.

According to embodiments wherein both lights and ornaments are connected to the electrical string or strings, they may be arranged at spaced intervals along the length of the main electrical string and/or secondary electrical string. Although it is aesthetically pleasing to alternately arrange the decorative lights and light emitting ornaments along the electrical strings, this configuration in not required and other arrangements may be utilized. Accordingly, embodiments of the decorative lighting assembly may include lights and light emitting ornaments that are randomly arranged along the length of the electrical strings.

According to one illustrative embodiment, the decorative lighting display includes a string of electrically connected lights and at least one ornament that is indicative of the Jewish holiday of Hanukkah. According to this embodiment, the decorative lighting display includes a plurality of lights and a plurality of ornaments selected from the Star of David, the Menorah, the dradle, and combinations thereof. Certain embodiments comprise a plurality of light emitting bulbs in white, blue, and yellow colors, or a combination of any of these colors, and a plurality of light emitting ornaments that are in the general shape or representation of the Star of David.

According to other illustrative embodiments, the decorative lighting assembly includes a main string of electrically connected lights, at least one secondary string transversely arranged and electrically connected to the main string, and at least one light emitting ornament electrically and detachably connected to the secondary string. According to these illustrative embodiments, the light emitting ornament is not attached directly to the main string via a receptacle along the main string. Rather, the light emitting ornament is electrically connected along the transversely arranged secondary electrical strings. According to certain configurations, the transversely arranged secondary electrical strings terminate with a receptacle that is adapted for electrical connection with a light emitting ornament. The light emitting ornaments are electrically connected to the lighting display assembly through these terminal electrical connectors or receptacles. According to other embodiments of the decorative lighting assembly, the transversely arranged secondary strings may also include one or more electrically connected light emitting lamps or light emitting diodes (LEDs).

According to certain embodiments, the decorative lighting assembly may include an electrical transformer. A transformer is an electrical device that is capable of transforming voltage from one level to another level. The transformer transforms voltage through magnetic couplings and electrical windings (ie, wires). A transformer generally includes a magnetic core and primary and secondary windings. The primary winding is connected to the source of power and the other windings are commonly referred to as the secondary windings. In the event that the voltage of the secondary winding is less than the voltage of the primary winding, then the transformer is referred to as a step down transformer. According to certain embodiments, the decorative lighting assembly includes a step down transformer in electrical connection with at least one of the main and secondary electrical strings. The step down transformer “steps down” the incoming voltage from the power source and provides the correct voltage input for the decorative lighting assembly. The inclusion of the step down transformer lowers the incoming voltage, while still permitting adequate electrical power the length of electrical wiring of the decorative lighting assembly. The use of the step down transformer minimizes or prevents damage to sensitive electrical components of the assembly.

Illustrative embodiment of the decorative lighting assembly will now be described in further detail with reference to the drawing Figures. It should be noted that the decorative lighting assembly is not intended to be limited to the illustrative embodiments shown in the drawing Figures, but shall include all variations and modifications within the scope of the claims.

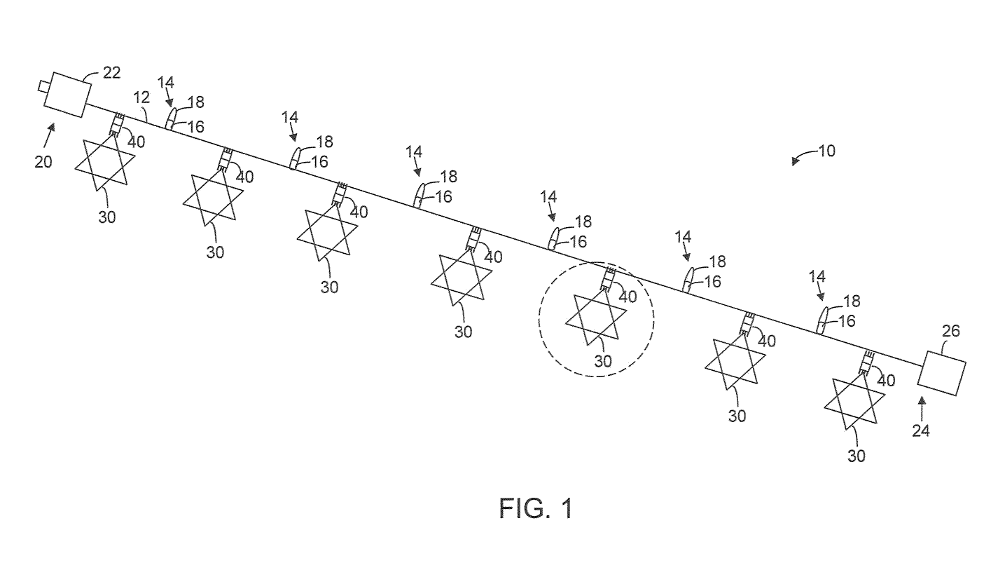

FIG. 1 shows an illustrative embodiment of the decorative lighting assembly 10. Decorative lighting assembly 10 comprises a string 12 of electrically connected lights 14. String 12 comprises elongated insulated electrical wire 12a. Light elements 14 include female sockets 16 that are adapted to receive lamp elements 18. Lights 14 are arranged in a spaced apart relationship along the electrical string 12.

Still referring to FIG. 1, string 12 terminates at one end 20 in an attachment plug element 22 for effecting interconnection of the string 12 to a source of electricity and/or to another string of lights. According to the illustrative embodiment shown in FIG. 1, a first end 20 terminates in an attachment plug element 22 for interconnecting the string 10 of lights to a source of electricity and a second end 24 of string 12 terminates in a attachment plug 26 that is adapted to effect interconnection of string of lights 10 to another string of lights having an attachment plug that is similar to attachment plug element 22 that is disposed near end 20 of electrical string 12.

Still referring to FIG. 1, a plurality of illuminable or light emitting ornaments 30 are electrically attached to string 12. Ornaments 30, according to the illustrative embodiment shown, are a plurality of the Jewish religious symbol of the Star of David. Like lights 14, the plurality of Stars of David 30 are arranged at spaced apart intervals along string 12. The Stars of David 30 are electrically connected to string 12 via suitable connectors 40.

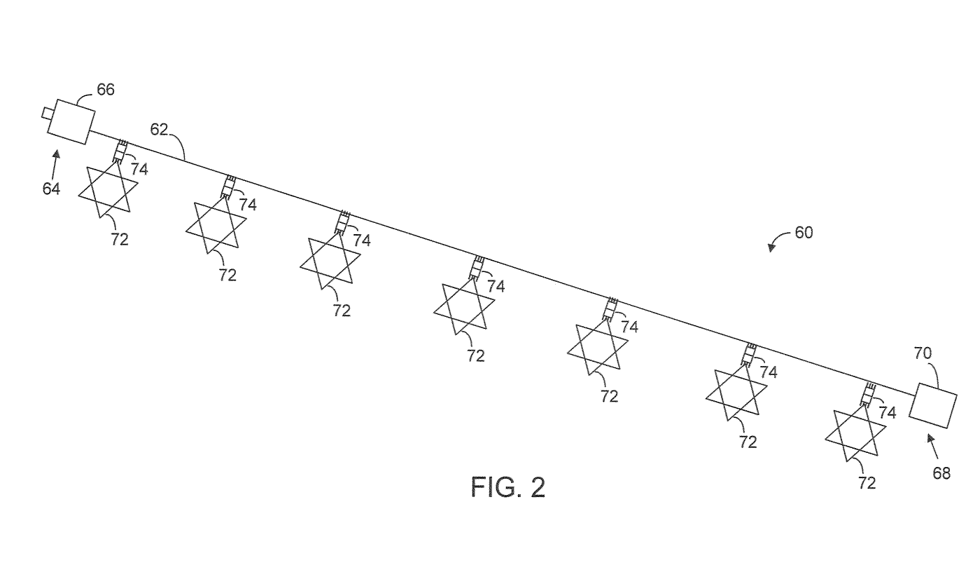

Turning to FIG. 2, another illustrative embodiment of the decorative assembly 60 is shown. Decorative assembly 60 comprises an elongated electrical cord or string 62. Like in FIG. 1, the elongated electrical string 62 comprises an elongated insulated electrical wire 62a. Still referring to FIG. 2, a first end 64 terminates in an attachment plug element 66 for interconnecting the string 62 of lights to a source of electricity and a second end 68 of string 62 terminates in an attachment plug 70 that is adapted to effect interconnection of string 62 to another string of lights having an attachment plug that is similar to attachment plug element 62 that is disposed near end 64 of electrical string 62.

Still referring to FIG. 2, a plurality of illuminable or light emitting ornaments 72 are electrically attached to string 62. Ornaments 72, according to the illustrative embodiment shown, are a plurality of the Jewish religious symbol of the Star of David. The plurality of Stars of David 72 are arranged at spaced apart intervals along string 62. The Stars of David 72 are electrically connected to string 62 via suitable connectors 74.

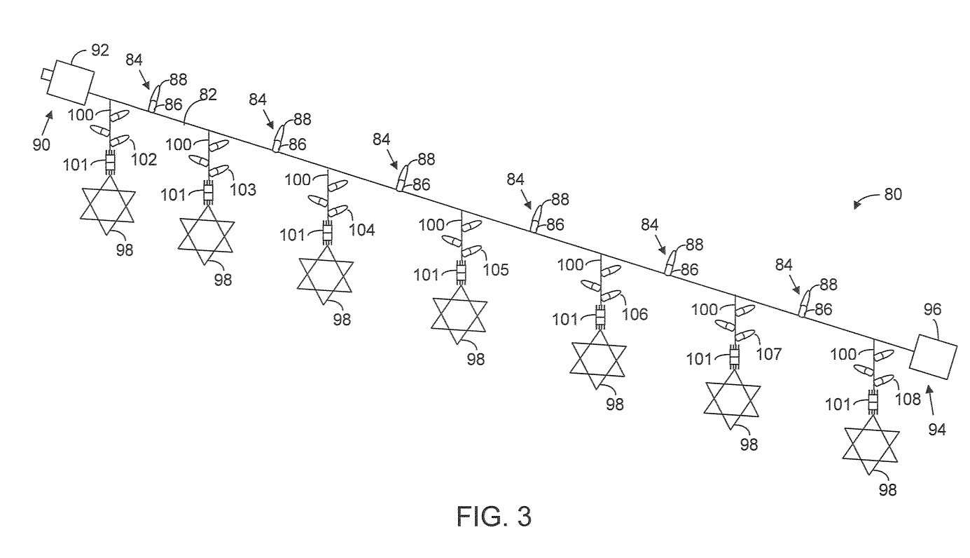

Now referring to FIG. 3, a further illustrative embodiment of the decorative lighting assembly 80 is shown. Decorative lighting assembly 80 comprises a string 82 of electrically connected lights 84. Light elements 84 include female sockets 86 that are adapted to receive lamp elements 88. Lights 84 are arranged in a spaced relationship along the string 82.

Still referring to FIG. 3, a first end 90 terminates in an attachment plug element 92 for interconnecting the string 82 of lights to a source of electricity and a second end 94 of string 82 terminates in an attachment plug 96 that is adapted to effect interconnection of string of lights 82 to another string of lights having an attachment plug that is similar to attachment plug element 92 that is disposed near end 90 of electrical string 82.

A plurality of illuminable or light emitting ornaments 98 are electrically attached to transversely arranged strings 100. Ornaments 98, according to the illustrative embodiment shown, are a plurality of the Jewish religious symbol of the Star of David. The plurality of Stars of David 98 are arranged at spaced intervals along string 92. The Stars of David 98 are electrically connected to string 82 via string 100 via suitable connectors 101. Arranged at spaced locations along strings 100 are lights 102-108.

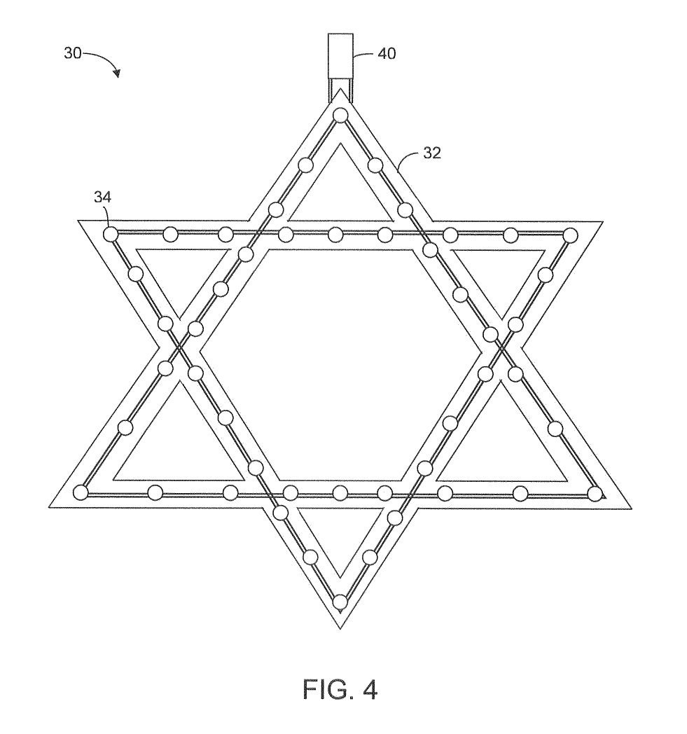

Now referring to FIG. 4, an illustrative embodiment of the light emitting ornament in the general shape of the Star of David 30 (FIG. 1), 72, (FIG. 2), 98 (FIG. 3) is shown. The Star of David 30 includes base 32 generally in the shape of the traditional Jewish symbol of the Star of David. The base may be constructed from any suitable rigid material that can house and/or support the light emitting sources. The base may be molded or extruded from a transparent plastic material. Utilizing a transparent plastic material permits the integral connection of the light emitting diodes within the interior of the base or to be embedded within the base material. Without limitation, the base 32 may be constructed from composite materials, metals, metal alloys, plastics, or combinations thereof. Integrally mounted within base 32 is a plurality of electrically connected lights 34. According to the illustrative embodiment shown in FIG. 4, the electrically connected lights 34 are arranged at spaced intervals along base 32 of the Star 30. Alternatively, lights 34 can be mounted on base 32 by providing a plurality of holes at spaced intervals on base 32. In this manner, the light emitting elements 34 protrude through holes and are displayed on the front side of base 32, while the electrical connecting wire 35 is substantially hidden on the backside of base 32. Disposed near one of the points of the Star 30 is a suitable connector 40 for electrically and detachably connecting the Star ornament 30 to the main electrical strings 12, 62, or 82 of the decorative lighting assembly. The Stars can be utilized in any of the illustrative embodiments shown in FIGS. 1-3.

Also disclosed is a decorative lighting assembly kit. The kit comprises an elongated string of electrically connected receptacles or connectors and at least one of (i) a plurality of different colored light emitting lamps adapted for electrical connection with at least one of said electrically connected receptacles or connectors, (ii) at least one light emitting ornaments adapted for electrical connection with at least one of said electrically connected receptacles or connectors and which represents at least one religious or non-religious secular occasion, or (iii) combinations of (i) and (ii).

According to certain embodiments, the kit comprises an elongated string of electrically connected receptacles or connectors and at least one of (i) a plurality of different colored light emitting lamps adapted for electrical connection with at least one of said electrically connected receptacles or connectors and (ii) at least one light emitting ornaments adapted for electrical connection with at least one of said electrically connected receptacles or connectors and which represents at least one religious or non-religious secular occasion.

According to further embodiments, the kit comprises an elongated string of electrically connected receptacles or connectors and at least one of (i) a plurality of different colored light emitting lamps adapted for electrical connection with at least one of said electrically connected receptacles or connectors and (ii) a plurality of light emitting ornaments adapted for electrical connection with at least one of said electrically connected receptacles or connectors and which represent at least one religious or non-religious secular occasion.

According to additional embodiments, the kit comprises an elongated string of electrically connected receptacles or connectors and at least one of (i) a plurality of different colored light emitting lamps adapted for electrical connection with at least one of said electrically connected receptacles or connectors and (ii) a plurality of light emitting ornaments adapted for electrical connection with at least one of said electrically connected receptacles or connectors and which represent more than one religious or non-religious secular occasion.

The electrically wired light emitting ornaments include at least one, and in illustrative embodiments, a plurality of integral light emitting sources such as a integral light emitting diodes (LEDs). That is, the ornament includes a base shape, dedicated and integrally engaged electrical wiring with the base, and a plurality of light emitting sources (such as light emitting diodes) integral with the base and in electrical interconnection by the electrical wiring. The ornament is electrically connected through a connector to a source of electricity. According to these embodiments, the term integral means that the light emitting diodes and electrical wiring are not separable from the base of the light emitting ornament. Consequently, the structure of the light emitting ornament is different from other displays that merely utilize a separate light source to illuminate a translucent cover, shade or shell that is merely positioned about the separate light source.

The main and secondary electrical strings, for embodiments having secondary strings, are provided with a plurality of electrical connectors for mating with suitable connectors on the user-selectable ornaments to provide a customized decorative lighting display. Thus, depending on the particular holiday or occasion, a user may select different ornaments that may be electrically connected to the main and/or secondary electrical strings to provide a customized light display for the desired holiday, occasion or event. By providing different interchangeable ornaments that include commonly designed electrical connectors, which are capable of mating with electrical connectors carried by the main and secondary electrical strings, a wide variety of decorative lighting displays may be created.

The decorative lighting assembly is adapted to be hung either inside a building or on the exterior of a building. For example, the decorative lighting assembly may be hung from window frames and casings, curtain rods, gutters, eaves, roofs, fences, poles, posts, bushes, shrubbery, and the like. Because the decorative lighting assembly kit may contain a number of different colored lights and light emitting ornaments representing religious holidays and secular occasions, then depending on the particular event (holiday or occasion), the user may select from the interchangeable light emitting lamps and light emitting ornaments to assemble a festive display for the particular event.

While the present invention has been described above in connection with certain illustrative embodiments, as shown in the various drawing Figures, it is to be understood that other similar embodiments may be used or modifications and additions may be made to the described embodiments for performing the same function of the present invention without deviating therefrom. Further, all embodiments disclosed are not necessarily in the alternative, as various embodiments of the invention may be combined to provide the desired characteristics. Variations can be made by one having ordinary skill in the art without departing from the spirit and scope of the invention. Therefore, the lighting assembly should not be limited to any single embodiment, but rather construed in breadth and scope in accordance with the recitation of the attached claims.

1. A decorative lighting assembly comprising:
an elongated electrical string having at least one connector for electrically connecting an electrically wired light emitting ornament to said electrical string; and
at least one electrically wired light emitting ornament electrically and detachably connected to said electrical string, wherein said electrically wired light emitting ornament comprises a base, electrical wiring integral with the base, and at least one light emitting source integral with the base.

2. The decorative lighting assembly of claim 1, wherein said light emitting source comprises at least one light emitting incandescent bulb integral with the base.

3. The decorative lighting assembly of claim 1, wherein said light emitting source comprises at least one light emitting diode integral with the base.

4. The decorative lighting assembly of claim 1, wherein said connector substantially prevents movement of said at least one ornament in response to external environmental factors.

5. The decorative lighting assembly of claim 1, further comprising at least one light emitting source, separate from said at least one ornament, electrically connected to said electrical string.

6. The decorative lighting assembly of claim 5, wherein said at least one light source and said at least one ornament are alternately arranged along said string.

7. The decorative lighting assembly of claim 1, further comprising a transformed in electrical connection with the electrical string.

8. The decorative lighting assembly of claim 5, wherein said at least one ornament is indicative of a religious holiday or non-religious celebration selected from the group consisting of New Year's, Christmas, Hanukkah, Valentine's Day, Sweetest Day, Easter, Memorial Day, Independence Day, Halloween, Thanksgiving and combinations thereof.

9. The decorative lighting assembly of claim 8, where said ornament indicative of Hanukkah is selected from the group consisting of representations of the Star of David, the Menorah, the dradle, and combinations thereof.

10. A decorative lighting assembly comprising:
an elongated main electrical string;
at least one secondary string transversely arranged and electrically connected to said main string; and
at least one electrically wired light emitting ornament electrically and detachably connected to at least one of said main and secondary electrical strings, wherein said electrically wired light emitting ornament comprises a base, electrical wiring integral with the base, and at least one light emitting source integral with the base.

11. The decorative lighting assembly of claim 10, wherein said light emitting source comprises at least one light emitting incandescent bulb integral with the base.

12. The decorative lighting assembly of claim 10, wherein said light emitting source comprises at least one light emitting diode integral with the base.

13. The decorative lighting assembly of claim 10, wherein said connector substantially prevents movement of said at least one ornament in response to external environmental factors.

14. The decorative lighting assembly of claim 10, further comprising at least one light emitting source, separate from said at least one ornament, electrically connected to said electrical string.

15. The decorative lighting assembly of claim 14, wherein said at least one light source and said at least one ornament are alternately arranged along said string.

16. The decorative lighting assembly of claim 10, further comprising a transformed in electrical connection with the electrical string.

17. The decorative lighting assembly of claim 14, wherein said at least one ornament is indicative of a religious holiday or non-religious celebration selected from the group consisting of New Year's, Christmas, Hanukkah, Valentine's Day, Sweetest Day, Easter, Memorial Day, Independence Day, Halloween, Thanksgiving and combinations thereof.

18. The decorative lighting assembly of claim 17, where said ornament indicative of Hanukkah is selected from the group consisting of representations of the Star of David, the Menorah, the dradle, and combinations thereof.

19. A decorative assembly comprising an elongated electrical string and at least one electrically wired and detachably connected light emitting ornament pendant from said string, wherein said electrically wired light emitting ornament comprises a base, electrical wiring integral with the base, and at least one light emitting source integral with the base.

20. The decorative lighting assembly of claim 19, wherein said light emitting source comprises at least one light emitting incandescent bulb integral with the base.

21. The decorative lighting assembly of claim 19, wherein said light emitting source comprises at least one light emitting diode integral with the base.

22. A decorative lighting assembly kit comprising:
an electrical string carrying a plurality of electrical connectors; and
at least one of (i) a plurality of electrically wired light emitting ornaments adapted for electrical connection with at least one of said electrical connectors, wherein said electrically wired light emitting ornament comprises a base, electrical wiring integral with the base, and at least one light emitting source integral with the base, or (ii) a combination of (a) a plurality of electrically wired light emitting ornaments comprising adapted for electrical connection with at least one of said electrical connectors, wherein said electrically wired light emitting ornament comprises a base, electrical wiring integral with the base, and at least one light emitting source integral with the base and (b) a plurality of different colored light emitting sources adapted for electrical connection with at least one of said electrical connectors.

23. The decorative lighting assembly of claim 22, wherein said light emitting source comprises at least one light emitting incandescent bulb integral with the base.

24. The decorative lighting assembly of claim 22, wherein said light emitting source comprises at least one light emitting diode integral with the base.

25. The decorative lighting assembly kit of claim 22, wherein said electrical string comprises an elongated main electrical string and at least one secondary string transversely arranged and electrically connected to said main string.

26. The decorative light assembly kit of claim 24, wherein said light emitting diodes are embedded or encased within said base.

27. The kit of claim 22, comprising light emitting ornaments indicative of (i) one or more different religious holiday, (ii) one or more different non-religious occasion, (iii) a professional sports team, (iv) a college sports team, (v) a high school sports team, (vi) a logo that identifies a city, (vii) a logo that identifies a community, (viii) a logo that identifies a state, (ix) a logo that identifies a country, (x) a representation of a trademark or logo of a business or corporate entity, (xi) letters, (xii) numbers, (xiii) symbols, (xiv) cartoon characters or (xv) combinations thereof.

28. The kit of claim 22, comprising a combination of light emitting ornaments indicative of at least one religious holiday and at least one non-religious occasion.

29. A decorative lighting assembly comprising:
an elongated electrical string having at least one connector adapted for electrically connecting an electrically wired ornament to said electrical string; and
at least one electrically wired light emitting ornament electrically and detachably connected to said electrical string; and
a transformer in electrical connection with the elongated electrical string.

30. The decorative lighting assembly of claim 29, wherein the transformer is a step down transformer.

31. The decorative lighting assembly of claim 29, wherein said connector substantially prevents movement of said at least one ornament in response to external environmental factors.

32. The decorative lighting assembly of claim 29, further comprising at least one light emitting source, separate from said at least one ornament, electrically connected to said electrical string.

33. The decorative lighting assembly of claim 29, wherein said at least one light source and said at least one ornament are alternately arranged along said string.

34. The decorative lighting assembly of claim 29, wherein said light emitting source comprises at least one light emitting incandescent bulb integral with the base.

35. The decorative lighting assembly of claim 29, wherein said light emitting source comprises at least one light emitting diode integral with the base.

36. The decorative lighting assembly of claim 29, wherein said at least one ornament is indicative of a religious holiday or non-religious celebration selected from the group consisting of New Year's, Christmas, Hanukkah, Valentine's Day, Sweetest Day, Easter, Memorial Day, Independence Day, Halloween, Thanksgiving and combinations thereof.

37. The decorative lighting assembly of claim 36, where said ornament indicative of Hanukkah is selected from the group consisting of representations of the Star of David, the Menorah, the dradle, and combinations thereof.

38. A decorative lighting assembly comprising:
an elongated main electrical string;
at least one secondary string transversely arranged and electrically connected to said main string;
at least one electrically wired light emitting ornament electrically and detachably connected to at least one of said main and secondary electrical strings; and
a transformer in electrical connection with the elongated electrical string.

39. The decorative lighting assembly of claim 38, wherein the transformer is a step down transformer.

40. The decorative lighting assembly of claim 38, wherein said connector substantially prevents movement of said at least one ornament in response to external environmental factors.

41. The decorative lighting assembly of claim 38, further comprising at least one light emitting source, separate from said at least one ornament, electrically connected to said electrical string.

42. The decorative lighting assembly of claim 38, wherein said at least one light source and said at least one ornament are alternately arranged along said string.

43. The decorative lighting assembly of claim 38, wherein said light emitting source comprises at least one light emitting incandescent bulb integral with the base.

44. The decorative lighting assembly of claim 38, wherein said light emitting source comprises at least one light emitting diode integral with the base.

45. The decorative lighting assembly of claim 38, wherein said at least one ornament is indicative of a religious holiday or non-religious celebration selected from the group consisting of New Year's, Christmas, Hanukkah, Valentine's Day, Sweetest Day, Easter, Memorial Day, Independence Day, Halloween, Thanksgiving and combinations thereof.

46. The decorative lighting assembly of claim 45, where said ornament indicative of Hanukkah is selected from the group consisting of representations of the Star of David, the Menorah, the dradle, and combinations thereof.

47. A decorative lighting assembly kit comprising:
an electrical string carrying a plurality of electrical connectors;
at least one of (i) a plurality of light emitting ornaments adapted for electrical connection with at least one of said electrical connectors, or (ii) a combination of (a) at plurality of light emitting ornaments adapted for electrical connection with at least one of said electrical connectors and (b) a plurality of different colored light emitting sources adapted for electrical connection with at least one of said electrical connectors; and
a transformer in electrical connection with the electrical string.

48. The kit of claim 47, wherein the transformer is a step down transformer.

49. The kit of claim 47, wherein said electrically wired light emitting ornaments comprises a base, electrical wiring integral with the base, and at least one light emitting source integral with the base.

50. The kit of claim 49, wherein said light emitting source comprises at least one light emitting incandescent bulb integral with the base.

51. The kit of claim 49, wherein said light emitting source comprises at least one light emitting diode integral with the base.

52. The kit of claim 51, wherein said light emitting diode is embedded or encased within said base.

53. The kit of claim 47, comprising light emitting ornaments indicative of (i) one or more different religious holiday, (ii) one or more different non-religious occasion, (iii) a professional sports team, (iv) a college sports team, (v) a high school sports team, (vi) a logo that identifies a city, (vii) a logo that identifies a community, (viii) a logo that identifies a state, (ix) a logo that identifies a country, (x) a representation of a trademark or logo of a business or corporate entity, (xi) letters, (xii) numbers, (xiii) symbols, (xiv) cartoon characters or (xv) combinations thereof.

54. The kit of claim 53, comprising a combination of light emitting ornaments indicative of at least one religious holiday and at least one non-religious occasion.
